(19) United States
(12) Patent Application Publication
(10) Pub. No.: US 2008/0020774 A1
(43) Pub. Date: Jan. 24, 2008

(54) Method and system for managing calls in a communication network

(75) Inventors: Anne M. Fancher, Naperville, IL (US); Bruce M. Drawert, Inverness, IL (US); Mohamad H. Fayad, Crystal Lake, IL (US); Daniel R. Orth, Downers Grove, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/488,244

(22) Filed: Jul. 18, 2006

(51) Int. Cl. H04Q 7/20

(52) U.S. Cl. 455/445; 455/428

(57) ABSTRACT

A method and system for managing calls in a communication network (100) is provided. The method includes establishing a voice path between the mobile station (102) and a called entity (110) through a switching center (104). The method also includes receiving a first request from the switching center at the serving node (106). The substitution information of a cell is then determined, followed by a measure-position request being sent from the serving node to the mobile station, and receiving a message at the serving node in response to the measure-position request. The message comprises either an error or location information of the mobile station. The substitution information is then sent from the serving node to the mobile station and the switching center, when the error is received. The location information is sent to the switching center, when the location information is received.

### FIELD OF THE INVENTION

The present invention relates generally to communication networks, and more specifically, to managing calls in a communication network.

### BACKGROUND OF THE INVENTION

A typical location enabled communication network includes a Mobile Subscriber (MS), a Mobile Switching Center (MSC), a Serving Mobile Location Center (SMLC), a Gateway Mobile Location Center (GMLC), and a Public Safety Answering Point (PSAP). As is known, an MS operates within a cell that is defined by the areas served by a base station that are strategically position throughout the network. Each MSC is associated with one or more base stations. Examples of the MSs include mobile handsets and mobile stations that are capable of determining their location by using known position-can be technologies. The MSC routes calls to and from the MS and forwards calls from the MS to a public telephone system or another MSC. The SMLC is capable of determining position co-ordinates of the MS in the communication network. The GMLC obtains the position co-ordinates of the MS that are derived by the SMLC and communicates the position co-ordinates to the PSAP and other devices within the network. The GMLC is capable of supporting multiple position-determination technologies. The SMLC and GMLC can communicate with each other through the MSC. Examples of position-determination technologies include Global Positioning System (GPS), time difference of arrival technology, enhanced observed time difference technology, cell tower information, and the like. The PSAP is an entity in the communication network that handles urgent calls, for example, calls made by the MS in the event of an emergency such as fire or when an ambulance is required. In order to respond to the urgent call, the PSAP uses the position co-ordinates of the MS, and it makes a request, referred to as a bid, to the GMLC for the position co-ordinate information.

Certain PSAPs have timers that cannot be changed, that is, the intervals between the triggering of these timers and the expiration of these timers cannot be modified. Sometimes, PSAPs are unable to receive the position co-ordinates of the MS in response to an initial bid made to the GMLC because the PSAPs' timers expire before the GMLC provides a response to the initial bid. Consequently, these PSAPs send a subsequent bid to the GMLC to obtain the MS position co-ordinates of the MS. This process of re-bidding slows down the ability of a PSAP to respond to emergency calls.

Currently, there are methods available that address the response time of the GMLC to the initial bid from a PSAP that impacts the PSAP's ability to respond. One of these methods involves X-Y routing. X-Y routing is intended to improve the accuracy of routing emergency calls to the appropriate PSAP by providing intermediate switching entities mobile location information when establishing the voice path to the PSAP. Thus, the GMLC is responsible for triggering the request to the SMLC and providing the mobile location to the MSC prior to establishing the voice path. However, this method does not decrease the response time to the initial bid from the PSAP. It also requires a change in the Quality of Services (QoS) parameters among the MSC, the MS, and the SMLC, where the change can increase the response time. It can delay the voice-path setup between the MS and the PSAP until the MSC receives location information from the SMLC. This delay further contributes to the slow response of the PSAP to an emergency call. X-Y routing and other techniques that provide the MS location information can take longer than some PSAP timer limitations and can require the MSC to re-bid for location information.

In view of the foregoing, a method and system for managing calls is needed where the response time of a GMLC for an initial bid from a PSAP is improved during an emergency call. In addition, a method and system for managing calls is needed that avoids the necessity of re-bidding for MS location information.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages, all in accordance with the present invention.

FIG. 1 is a block diagram of a communication network, where various embodiments of the present invention can be practiced;

FIG. 2 is a call-flow diagram illustrating a method of managing calls in a communication network, in accordance with an embodiment of the present invention;

FIG. 3 is a call-flow diagram illustrating a method for managing calls in a communication network, in accordance with an embodiment of the present invention;

FIGS. 4 and 5 is a flow diagram illustrating a method for managing calls in a communication network, in accordance with an embodiment of the present invention; and

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail the embodiments in accordance with the present invention, it should be observed that the embodiments reside primarily in combinations of method steps and apparatus components related to managing calls in a communication network. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

The term “another”, as used herein, is defined as at least a second or more. The terms “including” and/or “having,” as used herein, are defined as comprising.

A method for managing calls in a communication network is disclosed where a voice path is established between a mobile station and a called entity. The method further includes receiving a request to locate the mobile station. The request is made by a switching center to a serving node whereby the serving node obtains the location data of the mobile station from a reference-positioning network. A measure-position request is sent from the serving node to the mobile station, and a message from the mobile station is received in response to the measure-position request at the serving node. The message can be one of an error message or the location information of the mobile station. If an error message is received at the serving node, location assist data of the cell within which the mobile station operates is sent to the mobile station and position information is sent from the serving node to the switching center. If location information is received in response to the message, the location information is sent to the called entity such as a PSAP.

A system for managing calls in a communication network is also disclosed. The system includes a mobile station, a switching center, a serving node, a gateway node, and a called entity. The switching center is capable of facilitating communication between the serving node and the gateway node as well as between the mobile station and the called entity. The serving node is capable of determining substitution information of a cell, and is also capable of determining final location of the mobile station as well as substitute information for the location information such as position information regarding the location of the mobile station where the position information is an estimate of the mobile station from the cell within which it operates. The gateway node is capable of forwarding the substitution information, location information of the mobile station, and the final location to the called entity.

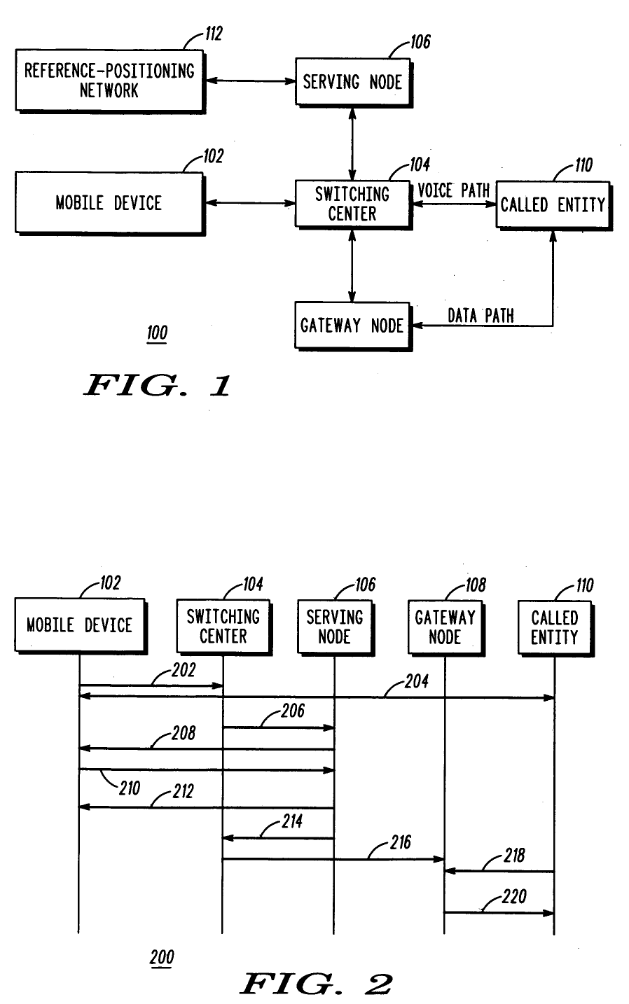

FIG. 1 is a block diagram of a communication network 100, in accordance with an embodiment of the invention. The communication network 100 includes a mobile station 102, a switching center 104, a serving node 106, a gateway node 108, and a called entity 110. The communication network 100 further includes a reference-positioning network 112 that can be communicably coupled to the serving node 106. For illustrative purposes, only one mobile station 102 and the switching center 104 are shown in FIG. 1. However, in a communication network 100 there are multiple switching centers that operate for the multiple cells and mobile stations that are within the network. The number of mobile stations and switching centers can vary, in accordance with different embodiments of the invention. Examples of the mobile station 102 include, but are not limited to, mobile handsets, cell phones, personal digital assistants and other equipment that can be capable of supporting a position-determination technology. Examples of position-determination technologies include Global Positioning System (GPS), and the like.

The mobile station 102 is communicably coupled to the switching center 104. In an embodiment, the mobile station 102 wirelessly communicates with the switching center 104 using known technologies such as Time Division Multiple Access (TDMA), Global System for Mobile Communications (GSM), Code Division Multiple Access (CDMA), wide-band CDMA, CDMA2000 and other wireless technologies. The mobile station 102 moves between cells within the network. Each cell is served by at least one base station (not shown). The operation of the base station is controlled at least in part by the switching centers 104. An example of the switching center 104 includes the Mobile Switching Center (MSC). The switching center 104 routes calls to and from the mobile station 102 and is capable of routing a call from the mobile station 102 to the called entity 110. The switching center 104 is also capable of establishing a voice path between the mobile station 102 and the called entity 110 using the base stations. In an embodiment, the switching center 104 is configured to send data including Call Back Number (CBN) of the mobile station 102, Cell Global Identifier (CGI) of the cell, and address of the switching center 104 to the gateway node 108.

As seen in FIG. 1, the switching center 104 is communicably coupled to the serving node 106. By connecting to the reference positioning network, the serving node is capable of obtaining the location of the mobile station. The serving node 106 is a network entity that is capable of obtaining and gathering the position co-ordinates of the mobile station 102 with assistance from the reference positioning network 112 and other sources. Examples of the serving node 106 include a Serving Mobile Location Center (SMLC), which is known by those of skill in the art. The serving node 106 is capable of instigating a compatible positioning method, based on communication between the serving node 106 and the mobile station 102 whereby the location of the mobile station 102 within a cell is determined. The serving node 106 is also capable of determining position information of a cell from where a call originates and can forward the position information to the switching center 104. The position information can be used as a substitute for the location information provided by the serving node 106. In an embodiment, the position information can be one of the latitude and/or longitude co-ordinates of the cell in which the mobile station 102 is operating. The serving node 106 is configured to support a database that includes data pertaining to the position information of a plurality of cells in the communication network 100. The serving node 106 is also capable of directing a measure-position request to the mobile station 102. The serving node 106 also communicates with the reference-positioning network to assist in obtaining location information regarding the actual location of the mobile station using known technologies such as GPS. In an embodiment, the serving node 106 is also capable of sending either the positioning or location information, described herein, of the mobile station 102 to the switching center 104, based on a message received from the mobile station 102 in response to the measure-position request.

Communication between the serving node 106 and the gateway node 108 is facilitated by the switching center 104. An example of the gateway node 108 includes a Gateway Mobile Location Center (GMLC). The gateway node 108 is communicably coupled to the switching center 104 and the called entity 110 and can communicate with the serving node 106 with the assistance of the switching center 104. As seen, a data path exists between the gateway node 108 and the called entity 110. The gateway node 108 is capable of receiving the final location from the switching center 104 and is capable of forwarding the position information regarding the cell within which the mobile station operates and/or the location information of the mobile station 102 to the called entity 110.

An example of the called entity 110 includes, but is not limited to, a Public Safety Answering Point (PSAP). In an embodiment, the switching center 104 is communicably coupled to the called entity 110 through an Emergency Services Network Entity (ESNE). The called entity 110 is capable of communicating with the mobile station 102 over the voice path through the switching center 104. The called entity 110 is also capable of communicating with the gateway node 108 through a data path and can request the gateway node 108 for the position co-ordinates of the mobile station 102.

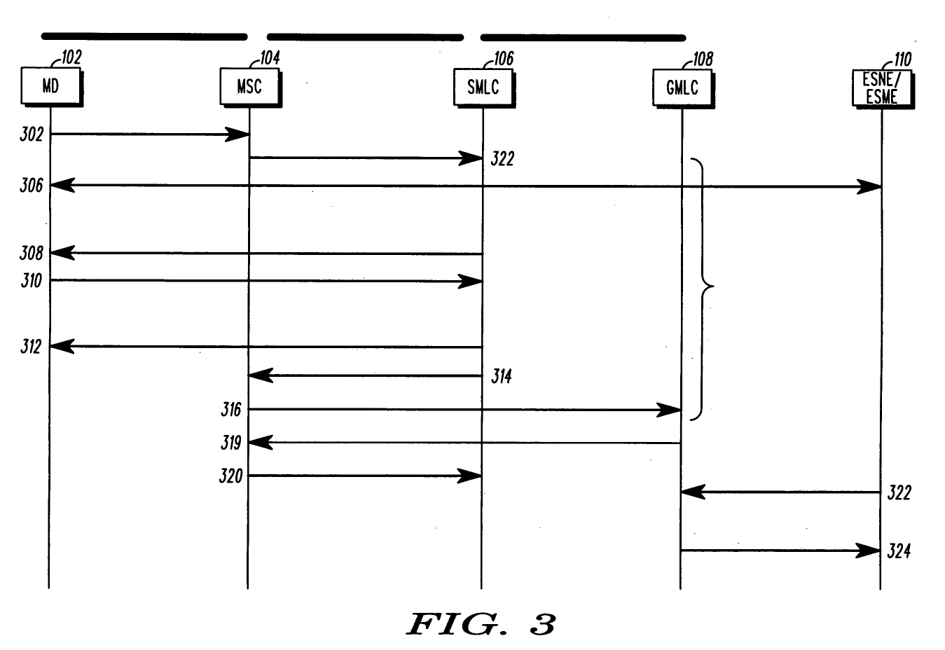

FIG. 2 is a call-flow diagram 200 that illustrates a method for managing calls in the communication network 100, in accordance with an embodiment of the present invention. To describe the call-flow diagram 200, reference will be made to FIG. 1, although it is understood that the call-flow can be implemented with reference to any other suitable embodiment of the invention. The call-flow diagram 200 is shown to include the mobile station 102, the switching center 104, the serving node 106, the gateway node 108, and the called entity 110.

A mobile station 102 originates 202 a call where the mobile station 102 operates within a cell that is served by a base station and a switching center 104. During the call origination, the mobile station 102 sends the Call Back Number (CBN) and other information to the switching center 104. In an embodiment, the call origination can be in the event of an emergency call in situations such as accidents or fires. After the call is originated, a voice path is established 204 by the switching center 104 between the mobile station 102 and the called entity 110. In an embodiment where the called entity is a PSAP, a timer present at the called entity 110 is triggered to begin after the voice path is established during which a request for the location of the mobile station 102 is expected to be sent by the PSAP. When a PSAP is called, the switching center 104 requests 206 from the serving node 106 the location of the mobile station 102 originating the call. This request may include Cell Global Identifier (CGI) of the cell, location-capability data of the mobile station 102, and Quality of Services (QoS) parameters.

In response to the request, the serving node 106 makes 208 a measure-position request to the mobile station 102. A message is sent 210 by the mobile station 102 to the serving node 106 in response to the measure-position request. The message can include either location information of the mobile station 102 as known by the mobile station 102 or an error message.

The error message represents the inability of the mobile station 102 to determine the position co-ordinates of the mobile station 102 when the measure-position request is received. In response to the error message, the serving node 108 sends 212 a message to the mobile station 102 for location assist data needed by the mobile station 102. In addition, the serving node 108 sends 214 a message to the switching center 104 with latitude and longitude data of the cell in which the mobile station 102 is operating. The switching center 104 sends 216 a message to the gateway node 108 which may includes CBN, cell latitude and longitude data and other position information known by the switching center 104 without having to access other sources. When the called entity requests 218 the location of the mobile station 102, the gateway node 108 responds 220 with location information if it has been obtained from the mobile station 102, or if an error message has been received from the mobile station, it returns the position information of cell latitude and longitude, obtained from the serving node.

After the subscriber location report and in response to at least a part of the call set up, the called entity 110 bids on the gateway node 108 for the position co-ordinates of the mobile station 102. In an embodiment, the request is an emergency services position request. The gateway node 108 responds to the called entity 110 with the information obtained from the mobile station 102 and the switching center 104. In an embodiment, the intermediate information includes the position information or location information. The position information is received at the called entity 110 before the timer present at the called entity 110 times out. In an embodiment, the time interval between the reception of the voice and receipt of the response from the gateway node 108 at the called entity 110 is less than four seconds for at least 95 percent of the time.

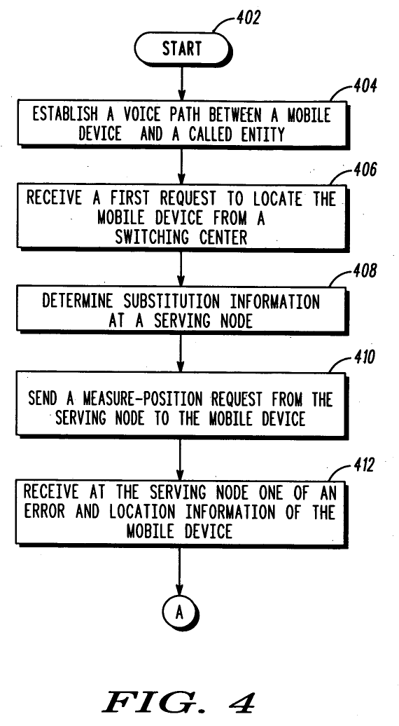

FIG. 3 illustrates a call flow diagram of the process 300 provided by the present information. As stated, the solution includes the mobile station 102, switching center 104, serving node 106, gateway node 108 and called entity 110. The mobile station 102 begins the process by requesting 302 a call with the switching center 104 and in particular an emergency call such as a 911 call. When the call is requested, the switching center 104 makes a location request 304 with the serving node 106 and includes CGI and QoS information in the request. As explained above, the serving node 106 is coupled to the reference positioning network 112 and can obtain the location assistance information from the network 112 in a known manner. Concurrently with the position location request 304, the call between the mobile station 102 and the called entity 110 is set up 306 using known techniques according to the network on which the mobile station 102 is operating. As this is an emergency call, the called entity 110 can be a PSAP and the call set up routine may contain an emergency service request key.

In response to the location request, the serving node 106 sends 308 a position request message to the mobile station 102. If the mobile station is location enabled with GPS or another positioning technology, the location of the mobile station 102 can be determined. The mobile station 102 can also respond 310 with measure position response that includes an error message which requests location assist data 210. The error message indicates to the serving node 106 that the mobile station is GPS enabled but needs GPS assistance data. The serving node 106 checks to see if the measure position response is an error message for location assist data. If it is a request for such data, the serving node 106 sends 312 an assistance data message to the mobile station 102. In addition, the serving node 106 sends 314 a response to the position location request made by the switching center 104 where the response is position information for the cell and mobile station and includes the cell latitude and longitude.

With the information now obtained by the switching center 104 regarding the location of the mobile station 102, a location response is sent 316 to the gateway node 108 where the response includes the mobile station's 102 CBN, cell latitude and longitude of the cell in which the mobile station 102 is operating, emergency services routing key, emergency services routing data and other data necessary to identify the emergency call to the called entity or PSAP. The time elapsed between the location request and the gateway node 108 obtaining data regarding the mobile station according to this process can be approximately 4 seconds, which is less than the time delay in receiving information regarding the location of the mobile station 102 as found in the prior art and before the timer expires. The improvement in response time can be attributed to the acquiring of location information of the mobile or position information of the cell during the call set up process and responding with the position information if an error message is received. Previously if an error message was received, then the mobile station would continue to attempt to obtain the location information, which could result in the time out of the called entity's timer. By substituting the position information of the cell in which the mobile station is operating for the location information of the mobile station, the called entity's timer does not time out and the called entity can proceed with its processes. In the case of an emergency, the called entity can dispatch emergency services in a more timely manner.

The gateway node 108 can respond 318 to the switching center 104 with a message that includes QoS data, switching center 104 identification data, emergency service routing key and mobile station identification. The location request 320 from the switching center 104 to the serving node 106 can include the CGI, and QoS data.

After voice setup in step 306 the called entity 110 makes an emergency services position request 322 of the gateway node 108. The response is needed within the timer interval that is set upon initialization of the call set up routine, as described above. And as described, the gateway node 108 has been obtaining the location information from the mobile station 102 or the position information from the serving node 106. Thus, the gateway node can respond 324 with the data that it has regarding the location of the mobile station 102 including the location information from the mobile station, the position information of the cell latitude and longitude, information from the serving node 104 or other position information known by and obtained from the mobile station 110. As can be understood in accordance with this description, if the serving node 106 received an error message requesting location assist data, then the position information is provided to the called entity 110. Otherwise, the location information from the mobile station is provided to the called entity. With the location information or the position information, the called entity can proceed with locating the mobile station 102 that requested the emergency services. In an embodiment, the called entity can request an update for the emergency services position request.

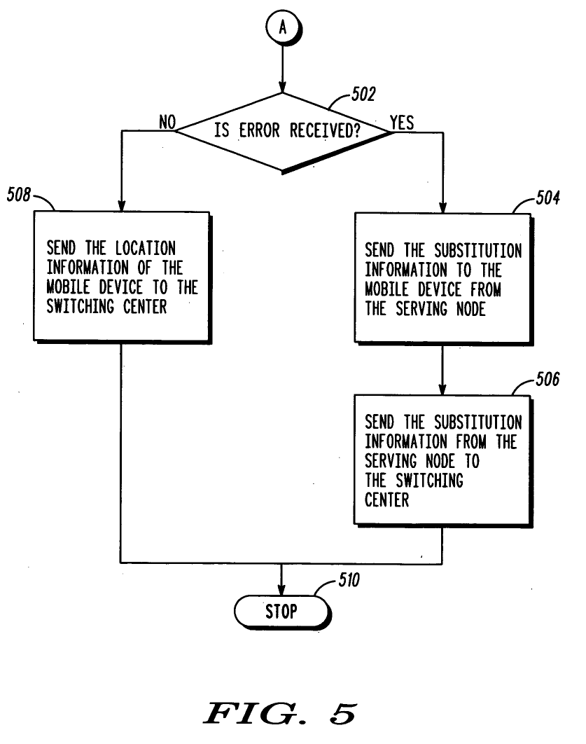

FIGS. 4 and 5 is a flow diagram for a method of managing calls in the communication network 100, in accordance with an embodiment of the present invention. To describe the method, reference will be made to FIG. 1, although it is understood that the method can be implemented with reference to any other suitable embodiment of the invention. In addition, the method can contain a greater or fewer numbers of steps than shown in FIGS. 4 and 5.

At step 402, the method begins. At step 404, a voice path is established between the mobile station 102 and the called entity 110 through the switching center 104, after a call originates from a cell to which the mobile station 102 belongs. During this call origination, the mobile station 102 communicates with the switching center 104. In an embodiment, a Call Back Number (CBN) is sent by the switching center 104 to the called entity 110. The voice path is established based on the originating cell information. A timer present at the called entity 110 is triggered when the voice path is established.

At step 406, a request to locate the mobile station 102 is received by the serving node 106. The request is generated by the switching center 104. The request includes information of the cell from where the call originates and location-capability data of the mobile station 102.

At step 408, position information pertaining to the cell is determined at the serving node 106. In an embodiment, the information is determined by retrieving data associated with the cell, from a database present at the serving node 106. In an embodiment, the information is cell latitude and cell longitude or other location identifying data.

At step 410, a measure-position request is sent from the serving node 106 to the mobile station 102. At step 412, a message is received at the serving node 106, in response to the measure-position request. The message can either be an error message or location information pertaining to the mobile station 102. The error represents the inability of the mobile station 102 to determine the position co-ordinates of the mobile station 102 when the message-position request is received. In an embodiment, the location information sent by mobile station includes latitude and longitude of the mobile station 102.

At step 502, the presence of an error in the message is determined. At step 504, the location assist data is sent from the serving node 106 to the mobile station 102 when the error is received with the message at the serving node 106. The location assist data includes data regarding the cell latitude and longitude or other cell position related data. At step 506, the position information is sent from the serving node 106 to the switching center 104 so that the switching center 104 can provide the position information to the called entity 10 through the gateway node 108 before expiration of the called entity's timer.

At step 508, the location information of the mobile station 102 is sent from the serving node 106 to the switching center 104 when the location information is received with the message at the serving node 106. At step 510, the method terminates.

In an embodiment, the present invention also includes determining the position information when the location information for the mobile station 102 is not available. This may include retrieving data associated with the cell with which the mobile station is operating and can include the cell latitude and longitude. In addition, the position information of the mobile station can include the cell latitude and cell longitude of the cell in which the mobile station is operating. In another embodiment, the present invention includes sending position information from the serving node 106 to the switching center 104. In addition, the position information can be sent from the switching center 104 to the gateway node 108.

A second request can also be sent from the called entity 110 to the gateway node 108 to acquire the location information or the position information. In response to the request, the called entity 110 may receive one of the position information and location information of the mobile station 102. As will be appreciated, the position information or the location information is to be received by the called entity before the expiration of the timer and in some embodiments within approximately 4 seconds.

When the position information is sent and eventually obtained by the called entity, the present invention includes determining a location estimate of the mobile station 102 using position determination technology such as GPS technology. The location estimate is sent from the mobile station 102 to the serving node 106. A final location of the mobile station can also be determined at the serving node 106 using the location estimate, which is then forwarded to the called entity 110.

As described above, the present invention solves the problem of called entities unable to receive required data pertaining to the position co-ordinates of the mobile station in time during an emergency. The present invention provides a method to improve the response time of the gateway node to initial bids made by the called entities. The present invention uses available knowledge from a chronology of events while a call progresses, to trigger an action to improve the response time. The present invention provides a method to trigger a timer present with the called entity when a voice path is established between the called entity and the mobile station, and provides a response from the gateway node to the called entity before the timer times out. Consequently, the called entity does not need to re-bid for the required data from the gateway node, thereby minimizing the delay in the response. The present invention brings down the average response time to less than four seconds and thereby enhances a called entity's ability to respond to a call in the event of an emergency. Moreover, the present invention does not require any new network elements to achieve the goal of beating the timer present at the called entity, to provide a faster response to the called entity.

It will be appreciated that embodiments of the invention described herein may be comprised of one or more conventional processors and unique stored program instructions that control the one or more processors to implement, in conjunction with certain non-processor circuits, some, most, or all of the functions of communication between mobile stations described herein. The non-processor circuits may include, but are not limited to, a radio receiver, a radio transmitter, signal drivers, clock circuits, power source circuits, and user input devices. As such, these functions may be interpreted as steps of a method to perform communication between various elements of a communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of managing calls in a communication network, the communication network comprising a mobile station, a switching center associated with a cell, a serving node, a gateway node, and a called entity, the method comprising:
establishing a voice path between the mobile station and the called entity;
receiving a request to locate the mobile station from the switching center;
sending a measure-position request from the serving node to the mobile station;
receiving at the serving node a message comprising one of an error and location information of the mobile station, in response to the measure-position request;
sending location assist data of the originating cell to the mobile station from the serving node when the error is received with the message at the serving node;
sending position information from the serving node to the switching center when the error is received with the message at the serving node; and
sending the location information of the mobile station to the switching center, when the location information of the mobile station is received with the message at the serving node.

2. The method as recited in claim 1, further comprising:
determining the position information for the mobile station location and
retrieving data associated with the originating cell from a database.

3. The method as recited in claim 1, wherein the position information comprises cell latitude and cell longitude.

4. The method as recited in claim 1, wherein the location information of the mobile station comprises latitude and longitude of the mobile station.

5. The method as recited in claim 1 further comprising:
sending the position information from the serving node to the switching center and
sending the position information from the switching center to the gateway node.

6. The method as recited in claim 1, wherein sending the location assist data, position information and the location information occurs before a timer present at the called entity expires.

7. The method as recited in claim 1 further comprising:
sending a second request from the called entity to the gateway node; and
receiving one of the position information and the mobile station location information at the called entity in response to the second request.

8. The method of claim 7 wherein receiving one of the position information and the mobile station location information occurs before a timer present at the called entity expires.

9. The method as recited in claim 1, wherein a time interval between the establishment of the voice path and the sending of the location assist data to the mobile station, position information to the mobile station and the location information to the gateway node is less than four seconds.

10. The method as recited in claim 1 further comprising:
determining a location estimate of the mobile station by using the position information and a position determination technology;
sending the location estimate from the mobile station to the serving node;
determining a final location of the mobile station at the serving node using the location estimate;
forwarding the final location of the mobile station to the gateway node through the switching center; and
sending the final location from the gateway node to the called entity.

11. The method according to claim 1, wherein the voice path is established through an Emergency Services Network Entity (ESNE).

12. A method of managing calls in a communication network, the communication network comprising a mobile station, a Mobile Switching Center (MSC) associated with a cell, a Serving Mobile Location Center (SMLC), a Gateway Mobile Location Center (GMLC), and a Public Safety Answering Point (PSAP), the method comprising:
establishing a voice path between the mobile station and the PSAP;
receiving a request to locate the mobile station from the MSC, wherein the request is received by the SMLC and includes information of the cell from where a call originates and location assist data of the mobile station; see claim 1
sending a measure-position request from the SMLC to the mobile station;
receiving at the SMLC one of an error and location information of the mobile station with a message, in response to the measure-position request;
sending location assist data of the originating cell to the mobile station from the SMLC when the error is received with the message at the SMLC;
sending the position information from the SMLC to the MSC, when the error is received with the message at the SMLC;
sending the location information of the mobile station to the MSC, when the location information of the mobile station is received with the message at the SMLC;
sending the position information from the MSC to the GMLC when the position information sent by the SMLC is received at the MSC;
sending the location information from the MSC to the GMLC when the location information sent by the SMLC is received at the MSC.

13. The method of claim 12 further comprising determining position information of the cell at the SMLC, wherein the position information is cell latitude and cell longitude.

14. The method as recited in claim 12, wherein determining the position information comprises retrieving data associated with the location of the mobile station from the cell in which the mobile station operates.

15. The method as recited in claim 12, wherein receiving the information regarding the location of the mobile station comprises obtaining one of the position information and the location information of the mobile station from the GMLC at the PSAP before a timer present at the PSAP times out, wherein the timer expires when the voice path is established.

16. The method as recited in claim 12, wherein time interval between the establishment of the voice path and the reception of intermediate information at the PSAP is less than four seconds for at least 95 percent of time. Check antecedent basis and revise out intermediate.

17. The method as recited in claim 12 further comprising:
determining a location estimate of the mobile station by using the position information and a position determination technology;
sending the location estimate from the mobile station to the SMLC;
determining a final location of the mobile station at the SMLC using the location estimate;
forwarding the final location of the mobile station to the GMLC through the MSC; and
sending the final location from the GMLC to the PSAP. No need for location estimate.

18. The method according to claim 12, wherein the voice path is established through an Emergency Services Network Entity (ESNE).

19. A system for managing calls in a communication network, the system comprising:
a serving node, wherein the serving node is capable of determining position information of a cell and a final location of a mobile station;
a gateway node, wherein the gateway node is capable of forwarding the substitution information, location information of the mobile station and the final location to a called entity associated with the cell from where a call originates; and
a switching center, wherein the switching center is capable of facilitating communication between the serving node and the gateway node.

20. The system as recited in claim 19, wherein the serving node is operable to:
retrieve data associated with the position information; and
provide the position information to the mobile station, wherein a location estimate is determined by the mobile station using the position information.
